(19) United States
(12) Patent Application Publication
(10) Pub. No.: US 2025/0378252 A1
(43) Pub. Date: Dec. 11, 2025

(54) HARDWARE PROGRAMMING OF REPLICATED PHYSICAL CIRCUIT MODULES WITHIN INTEGRATED CIRCUITS

(71) Applicant: Microsoft Technology Licensing, LLC, Redmond, WA (US)

(72) Inventor: Aditya Chandrasekar RAMACHANDRAN, Fremont, CA (US)

(73) Assignee: Microsoft Technology Licensing, LLC, Redmond, WA (US)

(21) Appl. No.: 18/734,701

(22) Filed: Jun. 5, 2024

(51) Int. Cl. G06F 30/343; G06F 30/347; G06F 119/18

(52) U.S. Cl. CPC G06F 30/343; G06F 30/347; G06F 2119/18

(57) ABSTRACT

An integrated circuit comprises a plurality of child circuit modules in which each child circuit module has a base configuration that is common to each of the plurality of child circuit modules. The base configuration includes: a semiconductor logic component, one or more auxiliary circuit components, and one or more signal driver components. The integrated circuit further comprises a parent circuit module overlaying the plurality of child circuit modules. The parent circuit module includes a plurality of electrical interconnects. For each child circuit module, an electrical interconnect provides an electrical connection to the semiconductor logic component. For a first subset of the child circuit modules, an electrical interconnect provides an electrical connection to the auxiliary circuit component, and for a second subset of the child circuit modules, an electric interconnect provides an electrical connection between a signal driver component and the auxiliary circuit component of that child circuit module.

### BACKGROUND

Integrated circuits utilize semiconductor materials, such as silicon, to form logic components (e.g., transistors) that can switch, amplify, or otherwise process electrical signals. A collection of interconnected logic components can form more complex logic devices within integrated circuits, including logic gates, multiplexers, demultiplexers, arithmetic circuits, flip-flops, counters, registers, programmable logic devices, etc.

A limiting factor in the development and implementation of integrated circuits includes the quantity of unique circuit designs encompassed by the integrated circuit. As each unique circuit design contained within an integrated circuit includes a different collection and/or arrangement of subcomponents, resource intensive tasks such as design process implementation, physical implementation of the design in hardware, and verification of its functionality and performance are conducted on a per-design basis. As such, the quantity of unique circuit designs contained within an integrated circuit directly impacts time, cost, labor, and other resources involved in the development and implementation of integrated circuits.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

According to an example disclosed herein, an integrated circuit comprises a plurality of child circuit modules in which each child circuit module has a base configuration that is common to each of the plurality of child circuit modules. The base configuration may include: a semiconductor logic component configured to provide a logic function, one or more auxiliary circuit components each configured to provide an auxiliary function, and a signal driver component configured to generate an electrical signal having a predefined signal value. The auxiliary circuit components can take the form of a feed-through circuit that provides a feed-through function for the child circuit module, as an example.

The integrated circuit further comprises a parent circuit module overlaying the plurality of child circuit modules that includes a plurality of electrical interconnects. For each child circuit module of the plurality of child circuit modules, the plurality of interconnects of the parent circuit module includes a logic-access electrical interconnect that provides an electrical connection to the semiconductor logic component of the child circuit module to enable access to its logic function.

The plurality of electrical interconnects of the parent circuit module further includes, for a first child circuit module of the plurality of child circuit modules, an auxiliary-access electrical interconnect that provides an electrical connection to a first auxiliary circuit component of the first child circuit module to enable access to its auxiliary function.

The plurality of electrical interconnects of the parent circuit module further includes, for a second child circuit module of the plurality of child circuit modules, a signal-select electrical interconnect that provides an electrical connection between the signal driver component and a first auxiliary circuit component of the second child circuit module to supply the predefined signal value to the first auxiliary circuit component.

### BRIEF DESCRIPTION OF THE DRAWINGS

FIG. 1 is a schematic diagram depicting a portion of an example integrated circuit that includes a plurality of child circuit modules.

FIG. 2 is a schematic diagram depicting the portion of the integrated circuit of FIG. 1 further including an example parent circuit module overlaid upon the plurality of child circuit modules.

FIG. 3 is a schematic diagram depicting the portion of the integrated circuit of FIG. 1 further including another example parent circuit module overlaid upon the plurality of child circuit modules.

FIG. 4 is a schematic diagram depicting a detailed view of a boundary region between an example child circuit module and an example parent circuit module.

FIG. 5 is a schematic diagram depicting a detailed view of another boundary region between an example child circuit module and an example parent circuit module.

### DETAILED DESCRIPTION

As briefly introduced above, time, cost, labor, and other resources involved in the development and implementation of integrated circuits can be driven by the quantity of unique circuit designs contained within the integrated circuit. Each unique circuit design within an integrated circuit typically relies upon a dedicated investment in resources to develop, implement, and verify functionality and performance of the design.

Replicated design is one approach to reducing time, cost, labor, and other resource expenditure in the development and implementation of an integrated circuit. Replicated design favors replication or reuse of a given circuit design by incorporating multiple circuit modules, cells, or blocks into the integrated circuit that are each a physical instance or embodiment of that design. Replicated design relies on the use of multiple circuit modules sharing a common circuit design rather than relying on multiple different circuit designs to achieve similar functionality and performance. The replication or reuse of a circuit design within an integrated circuit can be referred to as multiply-instantiated blocks (MIB) or multiply-instantiated modules (MIM).

One challenge associated with replicated design within integrated circuits is that each circuit module is expected to be identical to each other instance of that circuit module. Even small differences between two circuit modules can necessitate separate design-related tasks, including design process implementation, physical implementation of the design in hardware, and verification of its functionality and performance.

Another challenge associated with replicated design is compliance with design for test (DFT) requirements or protocols. DFT, within the context of integrated circuits, may provide that logic can be accessed on all replicated instances of a circuit design in an unbroken chain (e.g., scan chain). Furthermore, for some physical implementations of a replicated design, it may not be possible to create an unbroken chain using a common DFT structure.

Another challenge associated with replicated design includes identifying and distinguishing specific instances of the replicated design within a set of circuit modules. In some implementations, it can be beneficial to utilize a unique identifier for each circuit module of an integrated circuit. As an example, multiple instances of a replicated design can be assigned a binary value that is used to identify each instance within an integrated circuit. Prior approaches have either utilized the same identifier for each instance of the replicated design, or have enabled identification of specific instances in a manner that introduces differences between physical circuit modules that break or deviate from the convention that each instance of the replicated design has the same circuit configuration.

Yet another challenge associated with the design and implementation of integrated circuits is the avoidance of unconnected module interfaces (e.g., pins or ports). For example, unconnected input pins or ports of a circuit module may result in a power supply short that could damage or destroy the integrated circuit. Thus, it may be desirable in at least some implementations to drive input interfaces of circuit modules at a constant or other predefined signal value to prevent damage to the integrated circuit. However, it may not be possible to maintain identical instances of the replicated design if a first instances includes a set of connected input pins and the input pins of the second instance are not connected or driven to a predefined signal value.

Various approaches have sought to resolve at least some of the challenges described above. One approach is to create a unique circuit design for each circuit module that expresses a unique signal value (e.g., for purposes of identification) within an integrated circuit. However, this approach increases the quantity of unique designs in proportion to the quantity of unique signal values. Another approach is to tie ports of the circuit modules to the desired signal value via a logic component that resides outside of the module (e.g., at the parent level). An example of this approach is to use an identifier of a circuit block as a port or set of ports that are programmed outside of the module. However, connecting ports of a circuit module to a desired signal value at a location outside of the module typically involves the use of intermediate components (e.g., transistors) called tie cells, as it can be impractical to connect the ports of the circuit module directly to the power supply or ground of the integrated circuit. This approach increases complexity of the integrated circuit as a design that is a parent of these instances of a replicated design includes associated infrastructure such as power supply and routing resources.

The design of parent modules tend to be very large on account of servicing multiple child modules as instances of a replicated design. The presence of logic components at the parent level that offer even minimal logic functionality also involves design-related tasks for the parent design that can include significant resource outlay and implementation effort. Significant benefits may accrue from not having any logic (e.g., transistor-based logic devices) at parent levels. This approach can be referred to as an abutted floorplan implementation, as an example.

In view of the above, problems persist in efforts to utilize replicated designs within integrated circuits while also ensuring that programmable features of the replicated designs do not rely upon logic components at the parent level.

Integrated circuits are disclosed herein that offer the potential to address some or all of the challenges discussed above in a manner that leverages a replicated design while also enabling an abutted floorplan implementation that does not rely upon logic components at the parent level.

As an example, the integrated circuits disclosed herein include a plurality of child circuit modules that are instances of a replicated design. Each child circuit module of the replicated design includes one or more signal driver components that generate a predefined signal value (e.g., a constant) that is exposed at ports of the child circuit module. The disclosed integrated circuits further include a parent circuit module that includes electrical interconnects to the one or more ports of the child circuit modules to enable selection of the predefined signal values on a per-instance or per-child module basis. As an example, the electrical interconnects of the parent circuit module include a physical wire formed of an electrically conductive metal (e.g., copper, gold, etc.) that does not itself include or rely upon logic components that would otherwise increase design overhead.

Accordingly, the disclosed integrated circuits offer the potential to simplify the parent level of a hierarchical design by using electrical interconnects in the form of physical wires without relying upon logic components (e.g., gates) at the parent level to configure the ports of child circuit modules. This approach recognizes that electrical interconnects of a parent circuit module that feature physical wires can be overlaid upon child circuit modules while being logically owned by the parent circuit module, thereby enabling multiple instances of a replicated design to be maintained across the child circuit modules. The disclosed approach offers the potential to improve design and implementation productivity and reduce the resources needed for the development of semiconductor projects by leveraging replicated design among child circuit modules through the ability to program signal values across the child circuit modules without having to reimplement the design process for each unique signal value or combination of signal values. Additionally, the disclosed approach enables implementation of parent circuit modules without associated logic to improve design and implementation productivity and reduce resource outlay at the parent level.

According to the disclosed approach, each child circuit module as an instance of a replicated design is capable of generating a superset of signal values for external configuration or selection by way of electrical interconnects of a parent circuit module without the addition of logic components at the parent circuit level. The superset of signal values that can be generated by each child circuit module can be exposed as ports that are accessible to the parent circuit module. Each of the child circuit modules further provide ports for input and output signals that are accessible to the parent circuit module, including ports that support communication with logic components of the child circuit module and feed-through pathways that facilitate communication with logic components of other child circuit modules.

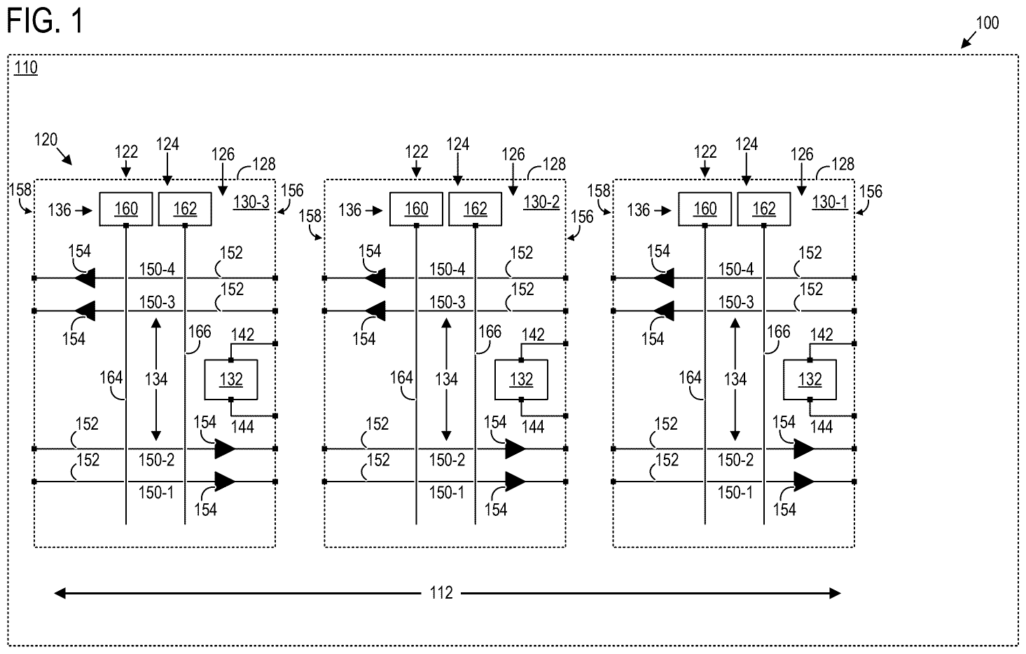

FIG. 1 is a schematic diagram depicting a portion 110 of an example integrated circuit (IC) 100. Portion 110 of IC 100 includes a plurality of child circuit modules 120 in which each child circuit module has a base configuration 122 that is common to (i.e., the same as) each other child circuit module of the plurality of child circuit modules 120. Accordingly, the plurality of child circuit modules 120 each having base configuration 122 is an example of a replicated design within an integrated circuit.

In the example of FIG. 1, the plurality of child circuit modules 120 includes a first child circuit module 130-1, a second child circuit module 130-2, and a third child circuit module 130-3, each having base configuration 122. While the plurality of child circuit modules 120 includes three child circuit modules 130-1, 130-2, and 130-3 in the example of FIG. 1, it will be understood that an integrated circuit can have any suitable quantity of child circuit modules as physical instances of a replicated design, including tens, hundreds, thousands, millions, or more child circuit modules, each having the same base configuration (e.g., 122).

In the example of FIG. 1, the plurality of child circuit modules 120 are arranged in series along an axis 112. In FIG. 1, for example, the series progresses from right to left to include first child circuit module 130-1, second child circuit module 132-1, and third child circuit module 134-1 as a sequence or chain of child circuit modules. As described in further detail herein, electrical signals sent or received by a child circuit module can pass through one or more other child circuit modules via a feed-through circuit that is present in each of the plurality of child circuit modules 120. This feed-through function can be used within the context of a scan chain implementation, as an example.

Base configuration 122 of each of the plurality of child circuit modules 120 includes a set of components 124 located within a region 126 that is defined by a boundary 128. In at least some implementations, the set of components 124 take the form of semiconductor components etched into a semiconductor material (e.g., silicon). As an example, region 126 can be formed from a semiconductor material, and the set of components 124 can be etched into the semiconductor material that corresponds to region 126. In at least some examples, the plurality of child circuit modules 120 can be formed by a common or shared semiconductor device of IC 100 in which respective instances of base configuration 122 corresponding to the child circuit modules are spaced apart from each other and form respective regions 126 of the semiconductor device.

In the example of FIG. 1, the set of components 124 of base configuration 122 include: a semiconductor logic component 132 configured to provide a logic function, a set of one or more auxiliary circuit components 134 each configured to provide an auxiliary function (e.g., a feed-through function), and a set of one or more signal driver components 136 each configured to generate an electrical signal having a predefined signal value (e.g., a logic value of 0 or 1).

Semiconductor logic component 132 includes one or more physical, logic devices formed within a semiconductor material. For example, semiconductor logic component 132 can include one or more transistors, logic gates (e.g., AND, OR, XOR, NOT, NAND, NOR, XNOR), multiplexers, demultiplexers, arithmetic circuits, flip-flops, counters, registers, programmable logic devices, etc. as subcomponents of semiconductor logic component 132. Examples of a logic function that can be provided by semiconductor logic component 132 include one or more of a switch, amplifier, logic operator (e.g., AND, OR, XOR, NOT, NAND, NOR, XNOR), multiplexer, demultiplexer, arithmetic, flip-flop, counter, register, and/or programmable function. For example, semiconductor logic component 132 can receive one or more input signals from a source, perform the logic function to the one or more input signals to generate a result, and provide the result as one or more output signals to a destination.

The set of components 124 of base configuration 122 can further include electrical pathways 142 and 144 that enable electrical signals to be input (i.e., input signals) to semiconductor logic component 132 (e.g., via electrical pathway 142) from a source located at or beyond boundary 128 of region 126, and that enable electrical signals to be output (i.e., output signals) from semiconductor logic component 132 (e.g., via electrical path 144) to a destination located at or beyond boundary 128 of region 126. As an example, electrical pathway 142 can take the form of an input electrical pathway to semiconductor logic component 132, and electrical pathway 144 can take the form of an output electrical pathway from semiconductor logic component 132. Thus, in this example, electrical pathways 142 and 144 form a bi-directional pair of electrical pathways that can be used to pass electrical signals bidirectionally with respect to semiconductor logic component 132.

The set of auxiliary circuit components 134 can include any suitable quantity of auxiliary circuit components. In the example of FIG. 1, the set of auxiliary circuit components 134 includes four auxiliary circuit components 150-1, 150-2, 150-3 and 150-4. As described in further detail herein, the quantity of auxiliary circuit components of base configuration 122 can depend on a quantity of child circuit modules that are contained in the plurality of child circuit modules 120. For example, the quantity of auxiliary circuit components of set 134 can increase in proportion to the quantity of child circuit modules.

In at least some examples, each auxiliary circuit component of the set of auxiliary circuit components 134 comprises a feed-through circuit that includes an electrical pathway 152 that traverses region 126 of the child circuit module between a first side 156 and a second side 158 of the region. In this example, each auxiliary circuit component, as a feed-through circuit, provides a feed-through function. Furthermore, in at least some examples, the feed-through circuit can further include a buffer 154 located along electrical pathway 152. In this example, each auxiliary circuit component additionally provides a buffering function via buffer 154. In the example of FIG. 1, buffer 154 of auxiliary circuit components 150-3 and 150-4 is configured as an input buffer in which first side 156 corresponds to an input side of the buffer, and second side 158 corresponds to an output side of the buffer. Furthermore, in the example of FIG. 1, buffer 154 of auxiliary circuit components 150-1 and 150-2 is configured as an output buffer in which first side 158 corresponds to an input side of the buffer, and second side 156 corresponds to an output side of the buffer.

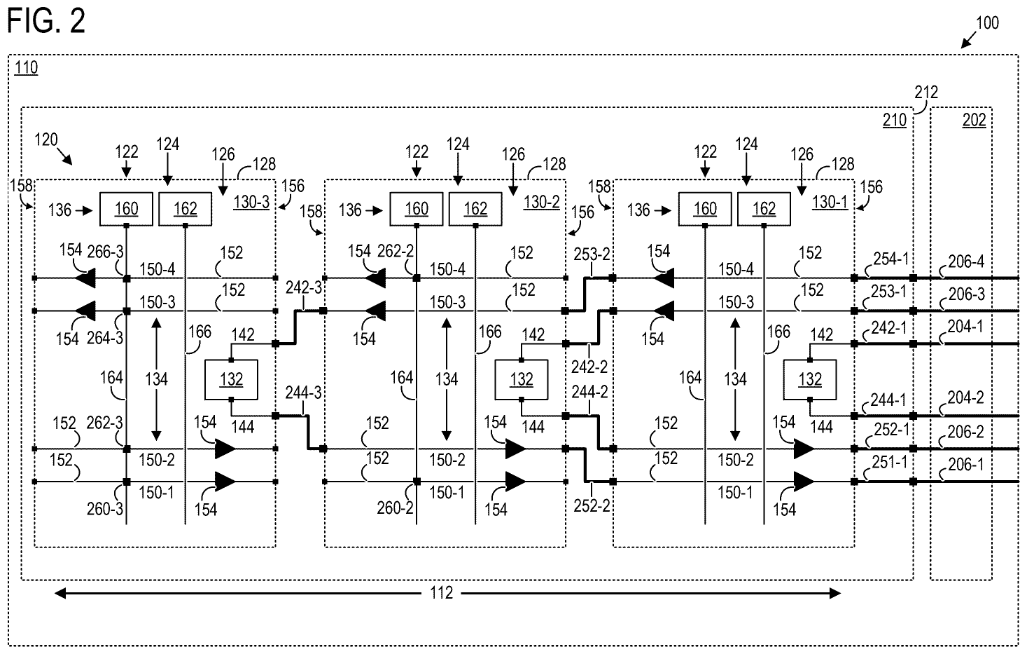

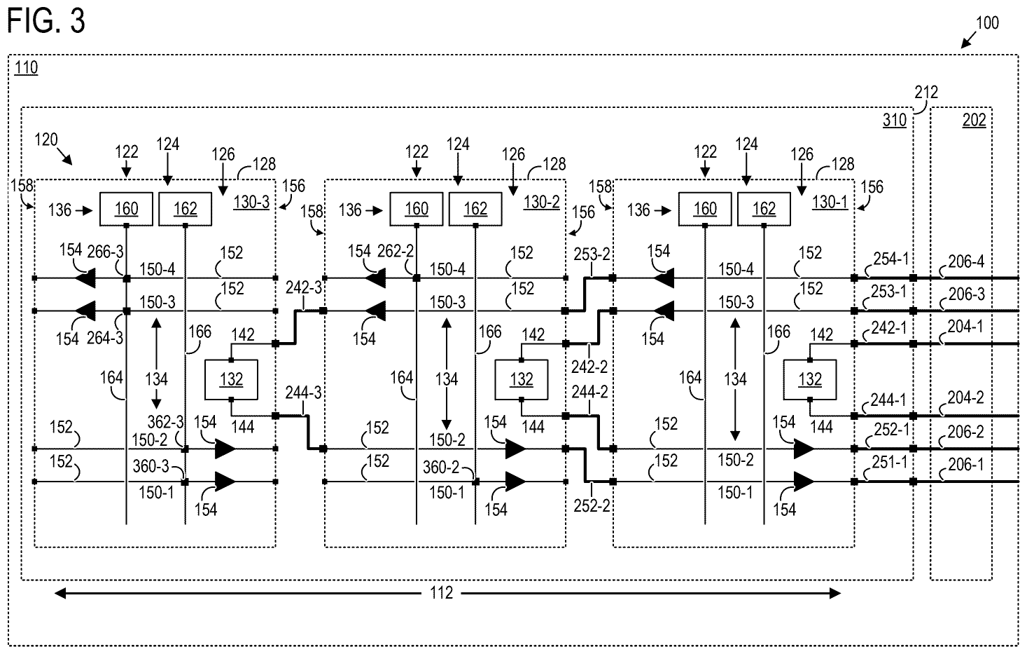

As described in further detail with reference to FIGS. 2 and 3, within the context of feed-through circuits, the set of auxiliary circuit components 134 can be used to pass electrical signals between a source located on a first side of a child circuit module and a destination located on an opposing, second side of the child circuit module. For example, electrical pathway 152 of auxiliary circuit components 150-1 and 150-2 can provide an output electrical pathway that provides a feed-through function, and electrical pathway 152 of auxiliary circuit components 150-3 and 150-4 can provide an input electrical pathway that provides a feed-through function. In these examples, at least two auxiliary circuit components can provide a bi-directional pair of electrical pathways that used to pass electrical signals bidirectionally across region 126 of a child circuit module.

In the example of FIG. 1, the set of signal driver components 136 includes a first signal driver component 160 that is configured to generate an electrical signal having a first predefined signal value, and a second signal driver component 162 that is configured to generate an electrical signal having a second predefined signal value. As an example, the first predefined signal value generated by first signal driver component 160 can represent a first logical value (e.g., a logical value of 0 within a binary value system), and the second predefined signal value generated by the second signal driver component 162 can represent a second logical value (e.g., a logical value of 1 within a binary value system). Signal driver components 160 may include one or more semiconductor logic devices (e.g., transistors) that are formed within a semiconductor material of region 126. For example, semiconductor logic devices of signal driver components 160 can process a power supply or ground signal of the integrated circuit to generate the predefined signal value.

The set of components 124 of base configuration 122 can further include a first electrical pathway 164 that is electrically coupled to first signal driver component 160. The electrical signal generated by first signal driver component 160 can be supplied to other components of the child circuit module via first electrical pathway 164. For example, some or all of the auxiliary circuit components of the set of auxiliary circuit components 134 can be electrically coupled to first electrical pathway 164 to supply the electrical signal generated by first signal driver component 160 to those auxiliary circuit components. In at least some examples, first electrical pathway 164 can span a region of the child circuit module that is traversed by electrical pathways 152 of the auxiliary circuit components to enable some or all of those auxiliary circuit components to be selectively coupled to first electrical pathway 164 using electrical interconnects, as described in further detail with reference to FIGS. 2 and 3.

The set of components 124 of base configuration 122 can further include a second electrical pathway 166 that is electrically coupled to second signal driver component 162. The electrical signal generated by second signal driver component 162 can be supplied to other components of the child circuit module via second electrical pathway 166. For example, some or all of the auxiliary circuit components of the set of auxiliary circuit components 134 can be electrically coupled to second electrical pathway 166 to supply the electrical signal generated by second signal driver component 162 to those auxiliary circuit components. In at least some examples, second electrical pathway 166 can span a region of the child circuit module that is traversed by electrical pathways 152 of the auxiliary circuit components to enable some or all of those auxiliary circuit components to be selectively coupled to second electrical pathway 166 using electrical interconnects, as described in further detail with reference to FIGS. 2 and 3.

As schematically depicted in FIG. 1, the set of signal driver component 136 and electrical pathways 164 and 166 are electrically decoupled from each auxiliary circuit component of the set of auxiliary circuit components 134 within each instance of base configuration 122. For example, electrical pathways 164 and 166 can occupy a different layer of the child circuit modules than electrical pathways 152 of the auxiliary circuit components. In the examples of FIGS. 2 and 3, electrical interconnects are selectively used to electrically couple one or more signal driver components to one or more auxiliary circuit components of a child circuit module.

FIG. 2 is a schematic diagram depicting portion 110 integrated circuit (IC) 100 further including a parent circuit module 210 overlaid upon the plurality of child circuit modules 120 of FIG. 1. As previously described with reference to FIG. 1, the plurality of child circuit modules 120, including child circuit modules 130-1, 130-2, and 130-3 each have base configuration 122.

Electrical interconnects of parent circuit module 210 can be used to selectively implement or otherwise augment the functionality of certain child circuit modules of the plurality of child circuit modules 120 without changing the design or configuration of those child circuit modules. As previously described, these electrical interconnects of the parent circuit module can take the form of physical wires formed of an electrically conductive metal (e.g., copper, gold, etc.) that do not rely on logic components (e.g., transistors) for their operation. In at least some examples, the parent circuit module does not include a semiconductor logic component, and instead utilizes electrical interconnects in the form of physical wires to selectively implement or otherwise augment the functionality of the child circuit modules.

In the example of FIG. 2, parent circuit module 210 includes a plurality of electrical interconnects that include, for each child circuit module of the plurality of child circuit modules 120, one or more logic-access electrical interconnects that each provide an electrical connection to semiconductor logic component 132 of that child circuit module to enable access to its logic function. As an example, parent circuit module 210 includes logic-access electrical interconnects 242-1 and 244-1 that each provide an electrical connection to semiconductor logic component 132 at first side 156 of first child circuit module 130-1 to enable access to its logic function. In this example, logic-access electrical interconnect 242-1 provides an electrical connection to semiconductor logic component 132 of first child circuit module 130-1 via its electrical pathway 142, and logic-access electrical interconnect 244-1 provides an electrical connection to semiconductor logic component 132 of first child circuit module 130-1 via its electrical pathway 144. As previously described with reference to FIG. 1, electrical pathway 142 can take the form of an input electrical pathway to semiconductor logic component 132, and electrical pathway 144 can take the form of an output electrical pathway from semiconductor logic component 132.

In the example of FIG. 2, first child circuit module 130-1 is the first child circuit module in a series of child circuit modules arranged along axis 112. Logic-access electrical interconnects 242-1 and 244-1 can extend to a boundary 212 of parent circuit module 210 to interface with other components of IC 100. For example, IC 100 includes electrical pathways 204-1 and 204-2 that interface with logic-access electrical interconnects 242-1 and 244-1 along boundary 212 of parent circuit module 210. Additionally, in this example, IC 100 includes a circuit component 206, represented schematically in FIG. 2, that interfaces with parent circuit module 210. Circuit component 206 of IC 100 can provide electrical signals to and receive electrical signal from the plurality of child circuit modules 120 via parent circuit module 210. For example, logic-access electrical interconnects 242-1 and 244-1 provide circuit component 206 of IC 100 with access to the logic function of semiconductor logic component 132 of first child circuit module 130-1.

For first child circuit module 130-1 of the plurality of child circuit modules 120, parent circuit module 210 further includes auxiliary-access electrical interconnects 251-1, 252-1, 253-1, and 254-1 that each provides a respective electrical connection to auxiliary circuit components 150-1, 150-2, 150-3, and 150-4 at first side 156 of the first child circuit module to enable access to their auxiliary function. In this example, interconnect 251-1 further provides an electrical connection to electrical pathway 206-1 of IC 100, interconnect 252-1 further provides an electrical connection to electrical pathway 206-2 of IC 100, interconnect 253-1 further provides an electrical connection to electrical pathway 206-3 of IC 100, and interconnect 254-1 further provides an electrical connection to electrical pathway 206-4 of IC 100. Accordingly, in this example, electrical pathways 206-1, 206-2, 206-3, and 206-4 interface with auxiliary-access electrical interconnects 251-1, 252-1, 253-1, and 254-1 along boundary 212 of parent circuit module 210.

Additionally, in this example circuit component 206 of IC 100 interfaces with parent circuit module 210 and can provide electrical signals to and receive electrical signal from the plurality of child circuit modules 120 via parent circuit module 210. For example, auxiliary-access electrical interconnects 251-1, 252-1, 253-1, and 254-1 provide circuit component 206 of IC 100 with access to the auxiliary function (e.g., a feed-through function) of auxiliary circuit components 150-1, 150-2, 150-3, and 150-4 of first child circuit module 130-1, enabling circuit component 206 to send and receive electrical signals with respect to semiconductor logic components of child circuit modules 130-2 and 130-3 located on an opposite side of first child circuit module 130-1.

As previously described with reference to FIG. 1, for each of the plurality of child circuit modules 120, the set of auxiliary circuit components 134 each include an electrical pathway 152 that traverses region 126 of the child circuit module between first side 156 and second side 158 of the auxiliary circuit component. In this example, the auxiliary function provided by each auxiliary circuit component includes at least a feed-through function, enabling circuit component 202 of IC 100 to send electrical signals to and receive electrical signals from semiconductor logic component 132 of child circuit modules 130-2 and 130-3 located on an opposing side of first child circuit module 130-1.

As an example, parent circuit module 210 further includes logic-access electrical interconnects 242-2 and 244-2 that each provides an electrical connection to semiconductor logic component 132 at first side 156 of second child circuit module 130-2 to enable access to its logic function. In this example, logic-access electrical interconnect 242-2 provides an electrical connection to semiconductor logic component 132 of second child circuit module 130-2 via its electrical pathway 142, and logic-access electrical interconnect 244-2 provides an electrical connection to semiconductor logic component 132 of second child circuit module 130-2 via its electrical pathway 144. As second child circuit module 130-2 is the second child circuit module in the series of child circuit modules arranged along axis 112, access to the logic function of its logic component 132 can be provided via logic-access electrical interconnects 242-2 and 244-2, each providing an electrical connection to a respective auxiliary circuit component of first child circuit module 130-1.

For second child circuit module 130-2, logic-access electrical interconnect 242-2 further provides an electrical connection to second side 158 of the auxiliary circuit component 150-3 of first child circuit module 130-1, thereby providing circuit component 202 with access to the logic function of semiconductor logic component 132 of the second child circuit module. As another example, for second child circuit module 130-2, logic-access electrical interconnect 244-2 further provides an electrical connection to second side 158 of the auxiliary circuit component 150-2 of first child circuit module 130-1, thereby providing circuit component 202 with access to the logic function of semiconductor logic component 132 of the second child circuit module.

Additionally, for second child circuit module 130-2 of the plurality of child circuit modules 120, parent circuit module 210 further includes auxiliary-access electrical interconnects 252-2 and 253-2 that each provides a respective electrical connection to auxiliary circuit components 150-2 and 150-3 at first side 156 of the second child circuit module to enable access to their auxiliary function. In the example of FIG. 2, auxiliary-access electrical interconnect 252-2 further provides an electrical connection to second side 158 of auxiliary circuit component 150-1 of first child circuit module 130-1, and auxiliary access electrical interconnect 253-2 further provides an electrical connection to second side 158 of auxiliary circuit component 150-4 of first child circuit module 130-1. Furthermore, in this example, the auxiliary function provided by each auxiliary circuit component of second child circuit module 130-2 includes at least a feed-through function, enabling circuit component 202 of IC 100 to send electrical signals to and receive electrical signals from semiconductor logic component 132 of third child circuit module 130-3 located on an opposing side of second child circuit module 130-2.

Parent circuit module 210 further includes logic-access electrical interconnects 242-3 and 244-3 that each provides an electrical connection to semiconductor logic component 132 at first side 156 of third child circuit module 130-3 to enable access to its logic function. In this example, logic-access electrical interconnect 242-3 provides an electrical connection to semiconductor logic component 132 of third child circuit module 130-3 via its electrical pathway 142, and logic-access electrical interconnect 244-3 provides an electrical connection to semiconductor logic component 132 of third child circuit module 130-3 via its electrical pathway 144. As third child circuit module 130-2 is the third child circuit module in the series of child circuit modules arranged along axis 112, access to the logic function of its logic component 132 can provided by logic-access electrical interconnects 242-3 and 244-3, each providing an electrical connection to a respective auxiliary circuit component of second child circuit module 130-2.

As an example, for third child circuit module 130-3, logic-access electrical interconnect 242-3 further provides an electrical connection to second side 158 of the auxiliary circuit component 150-3 of second child circuit module 130-2, thereby providing circuit component 202 with access to the logic function of semiconductor logic component 132 of the third child circuit module. As another example, for third child circuit module 130-3, logic-access electrical interconnect 244-3 further provides an electrical connection to second side 158 of the auxiliary circuit component 150-2 of second child circuit module 130-2, thereby providing circuit component 202 with access to the logic function of semiconductor logic component 132 of the third child circuit module.

In example of FIG. 2, auxiliary circuit components that are not used to provide the auxiliary function (e.g., a feed-through function) are electrically coupled to a signal driver component that is configured to generate an electrical signal having a predefined signal value. This approach can be used to supply a predefined signal value to unused auxiliary circuit components so that the auxiliary circuit components do not exhibit undefined electrical signal values.

For example, for second child circuit module 130-2, parent circuit module 210 further includes a signal-select electrical interconnect 260-2 that provides an electrical connection between signal driver component 160 and auxiliary circuit component 150-1 of second child circuit module 130-2. Signal-select electrical interconnect 260-2 can be used to supply the predefined signal value generated by signal driver component 160 of second circuit module 130-2 to auxiliary circuit component 150-1 of the second child circuit module. In this example, signal-select electrical interconnect 260-2 electrically couples electrical pathway 152 at an input side of buffer 154 of auxiliary circuit component 150-1 to electrical pathway 164 of signal driver component 160 for second child circuit module 130-2. However, it will be understood that a signal-select electrical interconnect of parent circuit module 210 could instead be used to electrically couple electrical pathway 152 at an input side of buffer 154 of auxiliary circuit component 150-1 to electrical pathway 166 of signal driver component 162 of second child circuit modules 130-2 to supply the predefined signal value generated by signal driver component 162 to the auxiliary circuit component.

Additionally, in this example, for second child circuit module 130-2, parent circuit module 210 further includes a signal-select electrical interconnect 262-2 that provides an electrical connection between signal driver component 160 and auxiliary circuit component 150-4 of second child circuit module 130-2. Signal-select electrical interconnect 262-2 can be used to supply the predefined signal value generated by signal driver component 160 of second circuit module 130-2 to auxiliary circuit component 150-4 of the second child circuit module. In this example, signal-select electrical interconnect 262-2 electrically couples electrical pathway 152 at an input side of buffer 154 of auxiliary circuit component 150-4 to electrical pathway 164 of signal driver component 160 for second child circuit module 130-2. However, it will be understood that a signal-select electrical interconnect of parent circuit module 210 could instead be used to electrically couple electrical pathway 152 of auxiliary circuit component 150-4 to electrical pathway 166 of signal driver component 162 of second child circuit module 130-2 to supply the predefined signal value generated by signal driver component 162 to the auxiliary circuit component.

FIG. 2 also depicts examples in which auxiliary circuit components of third child circuit module 130-3 are electrically coupled to a signal driver component of the third child circuit module by electrical interconnects of parent circuit module 210. For example, parent circuit module 210 further includes signal-select electrical interconnects 260-3, 262-3, 264-3, and 266-3 that provide an electrical connection between signal driver component 160 and electrical pathway 152 at an input side of buffer 154 of auxiliary circuit components 150-1, 150-2, 150-3, and 150-4, respectively. Accordingly, in this example, the electrical signal generated by signal driver component 160 can be provided to electrical pathway 152 at an input side of buffer 154 of each of auxiliary circuit components 150-1, 150-2, 150-3, and 150-4 of third child circuit module 130-3. However, it will be understood that signal-select electrical interconnects of parent circuit module 210 could instead be used to electrically couple electrical pathway 152 at an input side of buffer 154 of some or all of auxiliary circuit components 150-1, 150-2, 150-3, and 150-4 of third child circuit module 130-3 to signal driver component 162 of the third child circuit module.

As described above with reference to FIG. 2, a subset of the auxiliary circuit components of the set of child circuit modules 120 are supplied with electrical signals having a first predefined signal value generated by instances of first signal driver component 160. FIG. 3 is a schematic diagram depicting portion 110 integrated circuit (IC) 100 further including a parent circuit module 310 overlaid upon the plurality of child circuit modules 120 of FIG. 1. Parent circuit module 310 of FIG. 3 differs from parent circuit module 210 of FIG. 2 by including signal-select electrical interconnects that supply electric signals having a second predefined signal value generated by instances of second signal driver component 162 to certain auxiliary circuit components that differs from the first predefined signal value generated by instances of first signal driver component 160.

For example, for second child circuit module 130-2, parent circuit module 310 includes a signal-select electrical interconnect 360-2 that provides an electrical connection between second signal driver component 162 and electrical pathway 152 at an input side of buffer 154 of auxiliary circuit component 150-1 to supply the second predefined signal value to the auxiliary circuit component. As another example, for third child circuit module 130-3, parent circuit module 310 includes signal-select electrical interconnects 360-3 and 362-3 that provide electrical connections between second signal driver component 162 and electrical pathway 152 at an input side of buffer 154 of auxiliary circuit components 150-1 and 150-2, respectively, thereby supplying the second predefined signal value generated by the second signal driver component to auxiliary circuit components 150-1 and 150-2.

In at least some examples, signal-select electrical interconnects of a parent circuit modules can be configured to provide a particular combination of signal values to select auxiliary circuit components of the set of child circuit modules. In the example of FIG. 3, auxiliary circuit component 150-4 of second child circuit module 130-2 is supplied an electric signal having the first predefined signal value (e.g., a logical value of 0 within a binary value system) via signal-select electrical interconnect 262-2; auxiliary circuit component 150-1 of second child circuit module 130-2 is supplied an electric signal having the second predefined signal value (e.g., a logical value of 1 within a binary value system) via signal-select electrical interconnect 360-2; auxiliary circuit components 150-3 and 150-4 of third child circuit module 130-3 are supplied an electric signal having the first predefined signal value (e.g., a logical value of 0) via signal-select electrical interconnects 264-3 and 266-3; and auxiliary circuit components 150-1 and 150-2 of third child circuit module 130-3 are supplied an electric signal having the second predefined signal value (e.g., a logical value of 1) via signal-select electrical interconnects 360-3 and 362-3.

Accordingly, in the example of FIG. 3, child circuit module 130-2 can be uniquely identified among the plurality of child circuit modules 120 by the logical values 1 and 0 measured at signal-select electrical interconnects 360-2 and 262-2, respectively. Additionally, in this example, child circuit module 130-3 can be uniquely identified among the plurality of child circuit modules 120 by the logical values 1, 1, 0, and 0 measured at signal-select electrical interconnects 360-3, 362-3, 264-3, and 266-3, respectively.

The example configurations of FIGS. 2 and 3 can be used to provide a scan chain implementation in which the logical function of each instance of semiconductor logic component 132 of the plurality of child circuit modules 120 can be interrogated by circuit component 202 of IC 100 providing respective input signals to and by receiving output signals from each of the semiconductor logic components. Thus, the configurations of FIGS. 2 and 3 can be used in connection with design for test (DFT) requirements or protocols that rely on scan chain implementations.

In the examples of FIGS. 1-3, base configuration 122 includes four auxiliary circuit components in which a first pair of auxiliary circuit components (e.g., 150-1 and 150-4) can be used to pass electrical signals bidirectionally across region 126 of a first child circuit module to an instance of semiconductor logic component 132 of a second child circuit module, and a second pair of auxiliary circuit components (e.g., 150-2 and 150-3) can be used to pass electrical signals bidirectionally across region 126 of the first child circuit module to another instance of semiconductor logic component 132 of a third child circuit module.

The quantity of auxiliary circuit components of base configuration 122 can vary responsive to a quantity of child circuit modules that are contained in the plurality of child circuit modules 120 overlaid by a parent circuit module. Where the quantity of child circuit modules contained in the plurality of child circuit modules 120 is represented by the value “N”, the quantity of auxiliary circuit components of base configuration 122 represented by the value QA that are needed to support bidirectional communication of electrical signals with each child circuit module can be represented by the expression Q_{A}=2(N−1). For example, where the plurality of child circuit modules 120 contains 1,000 child circuit modules, base configuration 122 can include 1,998 auxiliary circuit components to support bidirectional communication with each instance of semiconductor logic component 132.

Within the context of child circuit modules that support at least two selectable signal values that are generated by a set of signal driver components, the inclusion of a quantity of auxiliary circuit components that scale with the quantity of child circuit modules enables all child circuit modules to be represented by a unique combination (e.g., a unique sequence) of signal values that are supplied to the auxiliary circuit components of the child circuit modules via signal-select electrical interconnects of the parent module. For example, where each child circuit module includes a set of 10 auxiliary circuit components, a corresponding signal value can be selected among the two or more available signal values for each of the 10 auxiliary circuit components via signal-select electrical interconnects of the parent circuit module to provide an ordered sequence of signal values (e.g., a binary number) that represents a unique identifier of the child circuit module. As a unique identifier, the ordered sequence of signal values for each child circuit module differs from the other child circuit modules.

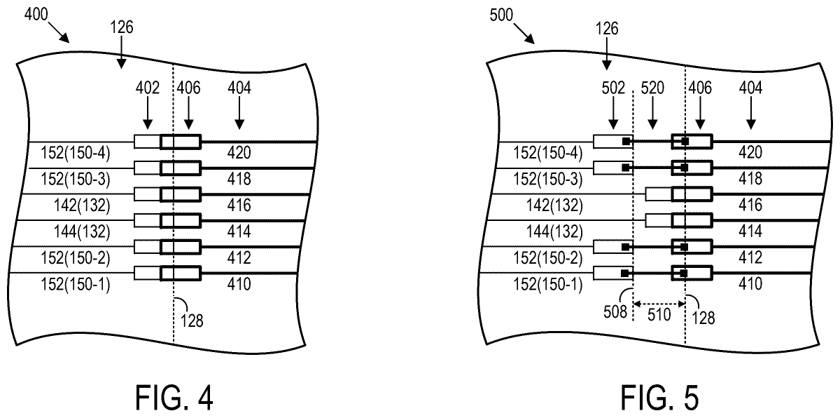

FIG. 4 is a schematic diagram depicting a detailed view of a boundary region 400 between an example child circuit module having base configuration 122 and an example parent circuit module. In FIG. 4, a portion of boundary 128 that defines region 126 of base configuration 122 is schematically depicted. Electrical pathways 142 and 144 for semiconductor logic component 132 and instances of electrical pathway 152 of auxiliary circuit components 150-1, 150-2, 150-3, and 150-4 are schematically depicted. In the example of FIG. 4, the electrical pathways of the child circuit module extend to boundary 128 and terminate at respective pins 402. Example electrical pathways 404 of the parent circuit module are also schematically depicted in FIG. 4 with reference numerals 410-420. In this example, electrical pathways 404 terminate at respective pins 406 that overlap with and/or contact pins 402 of base configuration 122 to establish electrical connections between the parent circuit module and the child circuit module. Electrical pathways 404 can refer to any of the electrical interconnects of parent circuit modules 210 and 310 of FIGS. 2 and 3. For example, electrical pathway 410 corresponds to electrical interconnect 251-1; electrical pathway 412 corresponds to electrical interconnect 252-1 or 252-2; electrical pathway 414 corresponds to electrical interconnect 244-1, 244-2, or 244-3; electrical pathway 416 corresponds to electrical interconnect 242-1, 242-2, or 242-3; electrical pathway 418 corresponds to electrical interconnect 253-1 or 253-2; and electrical pathway 420 correspond to electrical interconnect 254-1.

FIG. 5 is a schematic diagram depicting a detailed view of another boundary region 500 between an example child circuit module having base configuration 122 and an example parent circuit module. In FIG. 5, a portion of boundary 128 that defines region 126 of base configuration 122 is schematically depicted. Electrical pathways 142 and 144 for semiconductor logic component 132 and instances of electrical pathway 152 of auxiliary circuit components 150-1, 150-2, 150-3, and 150-4 are also schematically depicted in FIG. 5. In this example, electrical pathways 142 and 144 for semiconductor logic component 132 of the child circuit module extend to boundary 128 and terminate at respective pins 502. In the example of FIG. 5, instances of electrical pathways 152 of auxiliary circuit components 150-1, 150-2, 150-3, and 150-4 extend to an interior boundary 508 that is offset into region 126 from boundary 128 by a distance 510 (i.e., an offset distance). Distance 510 is greater than a distance that pins 406 of the parent circuit module project beyond boundary 128, thereby providing a gap or space between pins 502 of the child circuit module that are associated with the accessory circuit components and pins 406 of the parent circuit module that are configured to communicate with the accessory circuit components. Electrical interconnects 520 of the parent circuit module can be selective added to bridge distance 510 between pins 502 of the child circuit module and pins 406 of the parent circuit module. Electrical interconnects 520 in combination with electrical pathways 410, 412, 418, and 420 form the auxiliary-access electrical interconnects previously described with reference to FIGS. 2 and 3.

According to a disclosed example, an integrated circuit comprises: a plurality of child circuit modules in which each child circuit module has a base configuration that is common to each of the plurality of child circuit modules, wherein the base configuration includes: a semiconductor logic component configured to provide a logic function, one or more auxiliary circuit components each configured to provide an auxiliary function, and a signal driver component configured to generate an electrical signal having a predefined signal value; and a parent circuit module overlaying the plurality of child circuit modules, wherein the parent circuit module includes a plurality of electrical interconnects that include: for each child circuit module of the plurality of child circuit modules, a logic-access electrical interconnect that provides an electrical connection to the semiconductor logic component of that child circuit module to enable access to its logic function, for a first child circuit module of the plurality of child circuit modules, an auxiliary-access electrical interconnect that provides an electrical connection to a first auxiliary circuit component of the first child circuit module to enable access to its auxiliary function, and for a second child circuit module of the plurality of child circuit modules, a signal-select electrical interconnect that provides an electrical connection between the signal driver component and a first auxiliary circuit component of the second child circuit module to supply the predefined signal value to the first auxiliary circuit component of the second child circuit module.

In this example or other examples disclosed herein, for each of the plurality of child circuit modules, the one or more auxiliary circuit components comprise a feed-through circuit component that includes an electrical pathway that traverses a region of that child circuit module between a first side and a second side of the auxiliary circuit component. In this example or other examples disclosed herein, for the first child circuit module, the auxiliary-access electrical interconnect provides the electrical connection to the first side of the first auxiliary circuit component; and for the second child circuit module, the logic-access electrical interconnect further provides an electrical connection to the second side of the first auxiliary circuit component of the first child circuit module. In this example or other examples disclosed herein, the parent circuit module includes a pin interface to exchange signals with one or more other components of the integrated circuit on behalf of the plurality of child circuit modules; the plurality of child circuit modules are arranged in series along an axis; and the first child circuit module is located between the pin interface of the parent circuit module and the second child circuit module in the series. In this example or other examples disclosed herein, for each of the plurality of child circuit modules, the base configuration includes two or more auxiliary circuit components. In this example or other examples disclosed herein, the plurality of electrical interconnects of the parent circuit module further includes: an auxiliary-access electrical interconnect that provides an electrical connection to the first side of a second auxiliary circuit component of the first child circuit module, and an auxiliary-access electrical interconnect that provides an electrical connection between the second side of the second auxiliary circuit component of the first child circuit module and the first side of a second auxiliary circuit component of the second child circuit module. In this example or other examples disclosed herein, the plurality of child circuit modules includes a third child circuit module; and for the third child circuit module, the logic-access electrical interconnect further provides an electrical connection to the second side of the second auxiliary circuit component of the second child circuit module. In this example or other examples disclosed herein, for the third child circuit module, the plurality of electrical interconnects of the parent circuit module further includes a signal-select electrical interconnect that provides an electrical connection between the signal driver component and each of a first auxiliary circuit component and a second auxiliary circuit component of the third child circuit module to supply the predefined signal value to the first auxiliary circuit component and the second auxiliary circuit component of the third child circuit module. In this example or other examples disclosed herein, the parent circuit module includes a pin interface to exchange signals with one or more other components of the integrated circuit on behalf of the plurality of child circuit modules; the plurality of child circuit modules are arranged in series along an axis; the first child circuit module is located between the pin interface of the parent circuit module and the second child circuit module in the series; and the second child circuit module is located between the first child circuit module and the third child circuit module in the series. In this example or other examples disclosed herein, the signal driver component of the base configuration is a first signal driver component; and for each of the plurality of child circuit modules, the base configuration further includes a second signal driver component configured to generate an electrical signal having a predefined signal value that differs from the predefined signal value of the first signal driver component. In this example or other examples disclosed herein, the plurality of electrical interconnects of the parent circuit module further includes: for the third child circuit module, a signal-select electrical interconnect that provides an electrical connection between the first signal driver component and a first auxiliary circuit component of the third child circuit module, and for the third child circuit module, a signal-select electrical interconnect that provides an electrical connection between the second signal driver component and a second auxiliary circuit component of the third child circuit module. In this example or other examples disclosed herein, the feed-through circuit component further includes a buffer located along the electrical pathway. In this example or other examples disclosed herein, the auxiliary function comprises a signal feed-through function with respect to one or more other child circuit modules of the plurality of child circuit modules. In this example or other examples disclosed herein, the logic function includes one or more of: a switch, amplifier, logic operation, multiplexer, demultiplexer, arithmetic, flip-flop, counter, register, and/or programmable function. In this example or other examples disclosed herein, for the first child circuit module, the signal driver component is electrically decoupled from the first auxiliary circuit component.

According to another disclosed example, an integrated circuit comprises: a plurality of child circuit modules in which each child circuit module has a base configuration that is common to each of the plurality of child circuit modules, wherein the base configuration includes: a semiconductor logic component configured to provide a logic function, one or more auxiliary circuit components each configured to provide an auxiliary function, a first signal driver component configured to generate an electrical signal having a first predefined signal value, and a second signal driver component configured to generate an electrical signal having a second predefined signal value that differs from the first predefined signal value; and a parent circuit module overlaying the plurality of child circuit modules, wherein the parent circuit module includes a plurality of electrical interconnects that include: for each child circuit module of the plurality of child circuit modules, a logic-access electrical interconnect that provides an electrical connection to the semiconductor logic component of that child circuit module to enable access to its logic function, for a first child circuit module of the plurality of child circuit modules, a signal-select electrical interconnect that provides an electrical connection between the first signal driver component and a first auxiliary circuit component of the first child circuit module to supply the first predefined signal value to the first auxiliary circuit component of the first child circuit module, and for a second child circuit module of the plurality of child circuit modules, a signal-select electrical interconnect that provides an electrical connection between the second signal driver component and a first auxiliary circuit component of the second child circuit module to supply the second predefined signal value to the first auxiliary circuit component of the second child circuit module. In this example or other examples disclosed herein, the plurality of child circuit modules further includes a third child circuit module; the base configuration further includes two auxiliary circuit components each configured to provide the auxiliary function, and the plurality of electrical interconnects of the parent circuit module further includes: for each child circuit module of the plurality of child circuit modules, at least two signal-select electrical interconnects in which each signal-select electrical interconnect provides an electrical connection between one of the first signal driver component or the second signal driver component of the child circuit module, and a respective one of the two auxiliary circuit components of that child circuit module. In this example or other examples disclosed herein, the at least two signal-select electrical interconnects for each child circuit module generate an ordered sequence of signal values among the two auxiliary circuit components for each child circuit module that differs from the other child circuit modules.

According to another disclosed example, an integrated circuit comprises: a plurality of child circuit modules in which each child circuit module has a base configuration that is common to each of the plurality of child circuit modules, wherein the base configuration includes: a semiconductor logic component configured to provide a logic function, one or more auxiliary circuit components that each include a feed-through circuit configured to provide a feed-through function, and a first signal driver component configured to generate an electrical signal having a first predefined signal value; a second signal driver component configured to generate an electrical signal having a second predefined signal value that differs from the first signal value; and a parent circuit module overlaying the plurality of child circuit modules, wherein the parent circuit module includes a plurality of electrical interconnects that include: for each child circuit module of the plurality of child circuit modules, a logic-access electrical interconnect that provides an electrical connection to the semiconductor logic component of that child circuit module to enable access to its logic function, for at least some of the child circuit modules of the plurality of child circuit modules, an auxiliary-access electrical interconnect that provides an electrical connection between an auxiliary circuit component of that child circuit module and an auxiliary circuit component of another child circuit module, and for at least some of the child circuit modules of the plurality of child circuit modules, a first signal-select electrical interconnect that provides an electrical connection between the first signal driver component and an auxiliary circuit component of that child circuit module to supply the first predefined signal value to the auxiliary circuit component of that child circuit module, and for at least some of the child circuit modules of the plurality of child circuit modules, a second signal-select electrical interconnect that provides an electrical connection between the second signal driver component and an auxiliary circuit component of that child circuit module to supply the second predefined signal value to the auxiliary circuit component of that child circuit module. In this example or other examples disclosed herein, the parent circuit module does not include a semiconductor logic component.

It will be understood that the configurations and/or approaches described herein are exemplary in nature, and that these specific embodiments or examples are not to be considered in a limiting sense, because numerous variations are possible. The subject matter of the present disclosure includes all novel and non-obvious combinations and sub-combinations of the various processes, systems and configurations, and other features, functions, acts, and/or properties disclosed herein, as well as any and all equivalents thereof.

1. An integrated circuit, comprising:
a plurality of child circuit modules in which each child circuit module has a base configuration that is common to each of the plurality of child circuit modules, wherein the base configuration includes:
a semiconductor logic component configured to provide a logic function,
one or more auxiliary circuit components each configured to provide an auxiliary function, and
a signal driver component configured to generate an electrical signal having a predefined signal value; and
a parent circuit module overlaying the plurality of child circuit modules, wherein the parent circuit module includes a plurality of electrical interconnects that include:
for each child circuit module of the plurality of child circuit modules, a logic-access electrical interconnect that provides an electrical connection to the semiconductor logic component of that child circuit module to enable access to its logic function,
for a first child circuit module of the plurality of child circuit modules, an auxiliary-access electrical interconnect that provides an electrical connection to a first auxiliary circuit component of the first child circuit module to enable access to its auxiliary function, and
for a second child circuit module of the plurality of child circuit modules, a signal-select electrical interconnect that provides an electrical connection between the signal driver component and a first auxiliary circuit component of the second child circuit module to supply the predefined signal value to the first auxiliary circuit component of the second child circuit module.

2. The integrated circuit of claim 1, wherein for each of the plurality of child circuit modules, the one or more auxiliary circuit components comprise a feed-through circuit component that includes an electrical pathway that traverses a region of that child circuit module between a first side and a second side of the auxiliary circuit component.

3. The integrated circuit of claim 2, wherein for the first child circuit module, the auxiliary-access electrical interconnect provides the electrical connection to the first side of the first auxiliary circuit component; and
wherein for the second child circuit module, the logic-access electrical interconnect further provides an electrical connection to the second side of the first auxiliary circuit component of the first child circuit module.

4. The integrated circuit of claim 3, wherein the parent circuit module includes a pin interface to exchange signals with one or more other components of the integrated circuit on behalf of the plurality of child circuit modules;
wherein the plurality of child circuit modules are arranged in series along an axis; and
wherein the first child circuit module is located between the pin interface of the parent circuit module and the second child circuit module in the series.

5. The integrated circuit of claim 2, wherein for each of the plurality of child circuit modules, the base configuration includes two or more auxiliary circuit components.

6. The integrated circuit of claim 5, wherein the plurality of electrical interconnects of the parent circuit module further includes:
an auxiliary-access electrical interconnect that provides an electrical connection to the first side of a second auxiliary circuit component of the first child circuit module, and
an auxiliary-access electrical interconnect that provides an electrical connection between the second side of the second auxiliary circuit component of the first child circuit module and the first side of a second auxiliary circuit component of the second child circuit module.

7. The integrated circuit of claim 6, wherein the plurality of child circuit modules includes a third child circuit module;
wherein for the third child circuit module, the logic-access electrical interconnect further provides an electrical connection to the second side of the second auxiliary circuit component of the second child circuit module.

8. The integrated circuit of claim 7, wherein for the third child circuit module, the plurality of electrical interconnects of the parent circuit module further includes a signal-select electrical interconnect that provides an electrical connection between the signal driver component and each of a first auxiliary circuit component and a second auxiliary circuit component of the third child circuit module to supply the predefined signal value to the first auxiliary circuit component and the second auxiliary circuit component of the third child circuit module.

9. The integrated circuit of claim 8, wherein the parent circuit module includes a pin interface to exchange signals with one or more other components of the integrated circuit on behalf of the plurality of child circuit modules;
wherein the plurality of child circuit modules are arranged in series along an axis;
wherein the first child circuit module is located between the pin interface of the parent circuit module and the second child circuit module in the series; and
wherein the second child circuit module is located between the first child circuit module and the third child circuit module in the series.

10. The integrated circuit of claim 7, wherein the signal driver component of the base configuration is a first signal driver component; and
wherein for each of the plurality of child circuit modules, the base configuration further includes a second signal driver component configured to generate an electrical signal having a predefined signal value that differs from the predefined signal value of the first signal driver component.

11. The integrated circuit of claim 10, wherein the plurality of electrical interconnects of the parent circuit module further includes:
for the third child circuit module, a signal-select electrical interconnect that provides an electrical connection between the first signal driver component and a first auxiliary circuit component of the third child circuit module, and
for the third child circuit module, a signal-select electrical interconnect that provides an electrical connection between the second signal driver component and a second auxiliary circuit component of the third child circuit module.

12. The integrated circuit of claim 2, wherein the feed-through circuit component further includes a buffer located along the electrical pathway.

13. The integrated circuit of claim 1, wherein the auxiliary function comprises a signal feed-through function with respect to one or more other child circuit modules of the plurality of child circuit modules.

14. The integrated circuit of claim 1, wherein the logic function includes one or more of: a switch, amplifier, logic operation, multiplexer, demultiplexer, arithmetic, flip-flop, counter, register, and/or programmable function.

15. The integrated circuit of claim 1, wherein for the first child circuit module, the signal driver component is electrically decoupled from the first auxiliary circuit component.

16. An integrated circuit, comprising:
a plurality of child circuit modules in which each child circuit module has a base configuration that is common to each of the plurality of child circuit modules, wherein the base configuration includes:
a semiconductor logic component configured to provide a logic function,
one or more auxiliary circuit components each configured to provide an auxiliary function,
a first signal driver component configured to generate an electrical signal having a first predefined signal value, and
a second signal driver component configured to generate an electrical signal having a second predefined signal value that differs from the first predefined signal value; and
a parent circuit module overlaying the plurality of child circuit modules, wherein the parent circuit module includes a plurality of electrical interconnects that include:
for each child circuit module of the plurality of child circuit modules, a logic-access electrical interconnect that provides an electrical connection to the semiconductor logic component of that child circuit module to enable access to its logic function,
for a first child circuit module of the plurality of child circuit modules, a signal-select electrical interconnect that provides an electrical connection between the first signal driver component and a first auxiliary circuit component of the first child circuit module to supply the first predefined signal value to the first auxiliary circuit component of the first child circuit module, and
for a second child circuit module of the plurality of child circuit modules, a signal-select electrical interconnect that provides an electrical connection between the second signal driver component and a first auxiliary circuit component of the second child circuit module to supply the second predefined signal value to the first auxiliary circuit component of the second child circuit module.

17. The integrated circuit of claim 16, wherein the plurality of child circuit modules further includes a third child circuit module;
wherein the base configuration further includes two auxiliary circuit components each configured to provide the auxiliary function, and
wherein the plurality of electrical interconnects of the parent circuit module further includes:
for each child circuit module of the plurality of child circuit modules, at least two signal-select electrical interconnects in which each signal-select electrical interconnect provides an electrical connection between one of the first signal driver component or the second signal driver component of the child circuit module, and a respective one of the two auxiliary circuit components of that child circuit module.

18. The integrated circuit of claim 17, wherein the at least two signal-select electrical interconnects for each child circuit module generate an ordered sequence of signal values among the two auxiliary circuit components for each child circuit module that differs from the other child circuit modules.

19. An integrated circuit, comprising:
a plurality of child circuit modules in which each child circuit module has a base configuration that is common to each of the plurality of child circuit modules, wherein the base configuration includes:
a semiconductor logic component configured to provide a logic function,
one or more auxiliary circuit components that each include a feed-through circuit configured to provide a feed-through function, and
a first signal driver component configured to generate an electrical signal having a first predefined signal value;
a second signal driver component configured to generate an electrical signal having a second predefined signal value that differs from the first signal value; and
a parent circuit module overlaying the plurality of child circuit modules, wherein the parent circuit module includes a plurality of electrical interconnects that include:
for each child circuit module of the plurality of child circuit modules, a logic-access electrical interconnect that provides an electrical connection to the semiconductor logic component of that child circuit module to enable access to its logic function,
for at least some of the child circuit modules of the plurality of child circuit modules, an auxiliary-access electrical interconnect that provides an electrical connection between an auxiliary circuit component of that child circuit module and an auxiliary circuit component of another child circuit module, and
for at least some of the child circuit modules of the plurality of child circuit modules, a first signal-select electrical interconnect that provides an electrical connection between the first signal driver component and an auxiliary circuit component of that child circuit module to supply the first predefined signal value to the auxiliary circuit component of that child circuit module, and
for at least some of the child circuit modules of the plurality of child circuit modules, a second signal-select electrical interconnect that provides an electrical connection between the second signal driver component and an auxiliary circuit component of that child circuit module to supply the second predefined signal value to the auxiliary circuit component of that child circuit module.

20. The integrated circuit of claim 19, wherein the parent circuit module does not include a semiconductor logic component.
